(19) United States
(12) Patent Application Publication
(10) Pub. No.: US 2008/0302041 A1
(43) Pub. Date: Dec. 11, 2008

(54) Adjustable Decorative Doorway Insert

(76) Inventor: Bradley M. Nemeth, Oak Ridge, TN (US)

Correspondence Address: PITTS AND BRITTIAN P C, P O BOX 51295, KNOXVILLE, TN, 37950-1295, US

(21) Appl. No.: 11/758,027

(22) Filed: Jun. 5, 2007

(51) Int. Cl. B44F 7/00

(52) U.S. Cl. 52/312

(57) ABSTRACT

A decorative doorway insert for enhancing the look of a doorway. The doorway insert is provided for easy, non-destructive installation. The doorway insert is adjustable such that it is easily mounted within door openings of varying widths, and is removable in order to conveniently and inexpensively alter the look of the doorway as desired. The doorway insert is installed and removed without the need of tools, thus allowing it to be installed and removed quickly and easily by almost anyone. The doorway insert includes a left panel, a right panel, each of which is installed in the corresponding upper corners of the doorway, and a center panel which is adjustably attached to each of the left and right panels.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

### Field of Invention

The present invention pertains to the field of interior decorating. More particularly, this invention is directed to a temporary decorative element for enhancing the look of a door lintel.

### BRIEF SUMMARY OF THE INVENTION

The present invention is a decorative doorway insert for enhancing the look of a doorway. The doorway insert is provided for easy, non-destructive installation. The doorway insert is adjustable such that it will easily be mountable within door openings of varying widths, and is removable in order to conveniently and inexpensively alter the look of the doorway as desired. The doorway insert is installed and removed without the need of tools, thus allowing it to be installed and removed quickly and easily by almost anyone.

The doorway insert includes a left panel, a right panel, and a center panel. The left and right panels of the preferred embodiment are substantially mirror images of each other. Each defines a decorative front face, bottom edge and outer end, each of which is visible when installed. Similarly, the center panel defines a decorative front face and bottom edge. When installed, the front faces of the left, right and center panels cooperate to define a doorway insert front face. Similarly, the bottom edges of the left, right and center panels cooperate to define a doorway insert bottom edge.

The doorway insert is configured to be installed in a conventional doorway including a door liner on either side of the door frame and under the lintel. The right and left panels are removably secured to the door liners on either side of the door frame and under the lintel. The right and left panels may further be removably secured to either of the door trim and/or the door stop. The center panel is then releasably received on each of the left and right panels.

An attachment member is carried on the rear face of each of the left and right panels. The attachment member is dimensioned to engage the door liner on the corresponding side of the door frame and the door liner under the lintel. To this extent, the attachment member defines a vertical engagement surface configured to engage the side door liner and a horizontal engagement surface configured to engage the top door liner.

The center panel defines two ends, each defining a contour configured to closely receive the contour of the front face of the left and right panels. The center panel right end defines a contour to cooperatively receive the contour of the right panel front face. Likewise, the center panel left end defines a contour to cooperatively receive the contour of the left panel front face.

The center panel further defines a top member configured to engage the top surface of each of the left and right panels. A bottom member is also defined to be received under the bottom surfaces of each of the left and right panels. The bottom member defines an upward extension to be received behind the left and right panels in order to maintain the relative position of the center panel with respect to each of the left and right panels.

The doorway insert of the present invention is adapted to be received within various sized doorways. A length of each of the left and right panels defines a continuous cross section along a line parallel to the right end of the center panel. As a result of the continuous cross section in this region, the center panel is allowed to closely cooperatively receive the right panel at any location within the area. Thus, the doorway insert may be adjusted a length equal to twice the subject length, taking into account both the left and right panels.

Because the doorway insert is removably secured within the door opening, it will be understood that various configurations of the doorway insert may be selectively used for various purposes. The doorway insert may be configured to convey a particular architectural style, a theme for a party or child's room, or many other various reasons. Further, the doorway insert may be decorated to meet the needs of the user. Specifically, the doorway insert may be painted to match colors in the room, to include characters or a child's name in the child's room, various sports logos for a gathering of a sports crowd, or for any other tastes and preferences. For those uses of the doorway insert where it is to be removed and replaced frequently, it will be understood that a less permanent fastener such as a reusable putty-type adhesive.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a front elevation view of the decorative doorway insert, incorporating several features of the present invention;

FIG. 2 is a front elevation view of the decorative doorway insert, incorporating several features of the present invention, showing the left and right panels installed in a conventional doorway, and showing the center panel removed;

FIG. 3 is perspective view of the reverse of the right panel of the present invention;

FIG. 4 a top plan view, in section taken along 4-4 of FIG. 2, showing the right panel of the present invention when installed in a conventional doorway;

FIG. 5 a right end view, in section taken along 5-5 of FIG. 2, showing the right panel of the present invention when installed in a conventional doorway;

FIG. 6 a perspective view of the reverse of the center panel of the present invention;

FIG. 7 is an exploded end view illustrating the cooperative engagement between the center panel and each of the left and right panels of the present invention;

FIG. 8 is the end view of FIG. 7 showing the panels assembled; and

FIG. 9 is a front elevation view of a portion of the decorative doorway insert, incorporating several features of the present invention, and illustrating the adjustability of the center panel with respect to the right panel.

### DETAILED DESCRIPTION OF THE INVENTION

A decorative doorway insert for enhancing the look of a doorway. The doorway insert is provided for easy installation. The doorway insert is illustrated generally at 10 in the Figures. The doorway insert 10 is adjustable such that it will easily be mountable within doorways 70 of varying widths. Further, the doorway insert 10 is removable in order to conveniently and inexpensively alter the look of the doorway 70 as desired. In the preferred embodiment, the doorway insert 10 is installed and removed without the need of tools, and using non-destructive fasteners 84, thus allowing the doorway insert 10 to be installed and removed quickly and easily by almost anyone.

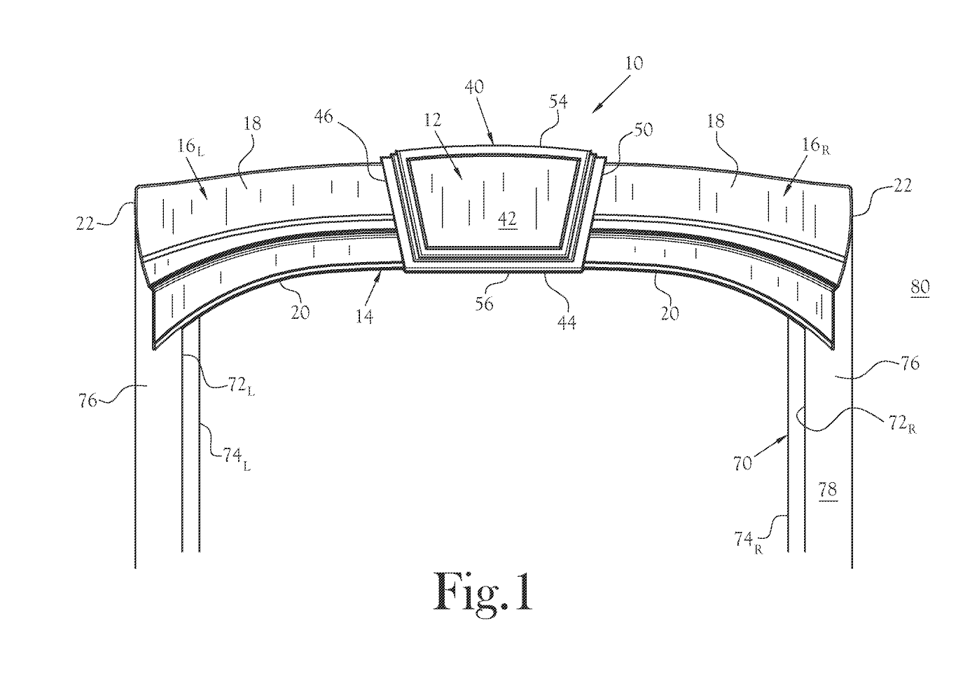

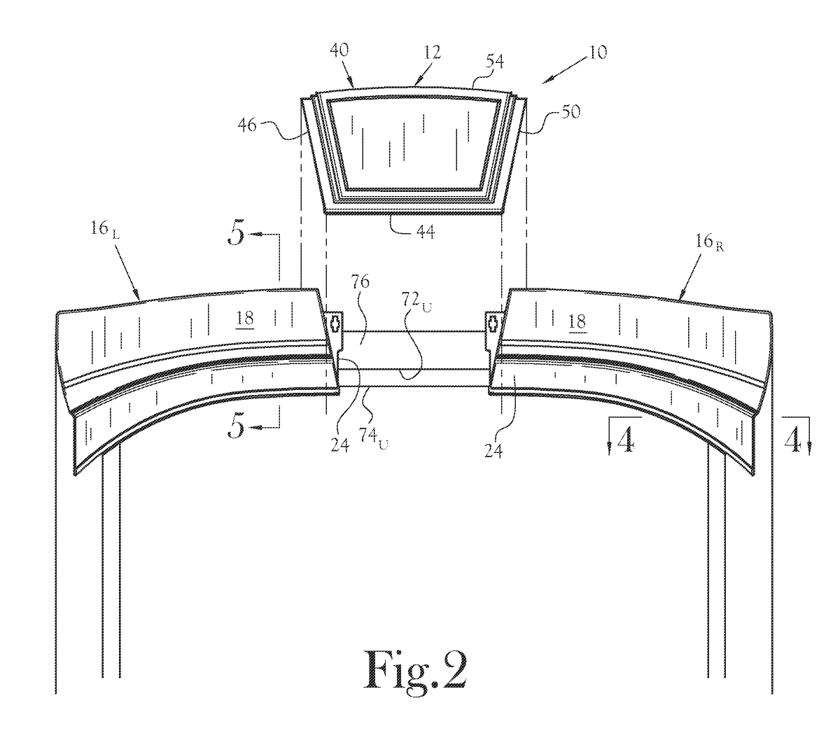

FIG. 1 and FIG. 2 illustrate the doorway insert 10 of the present invention. Referring to FIG. 1, the doorway insert 10 includes a left panel 16_{L}, a right panel 16_{R}, and a center panel 40. FIG. 2 more clearly illustrates the left panel 16_{L}, the right panel 16_{R} and the center panel 40. In this figure, it is illustrated that each of the left and right panels 16_{L}, 16_{R} are installed prior to the installation of the center panel 40. In the illustrated embodiment, the left and right panels 16_{L}, 16_{R} are substantially mirror images of each other. Each defines a decorative front face 18, bottom face 20 and outer end 22. Each of these is visible when installed. Each of the left and right panels 16_{L}, 16_{R} further defines an interior end 24 configured to receive the center panel 40. Similarly, the center panel 40 defines a decorative front face 42 and bottom face 44. When installed as illustrated in FIG. 1, the front faces 18 of the left and right panels and the center panel front face 42 cooperate to define a doorway insert front face 12. Similarly, the bottom faces 20 of the left and right panels 16_{L}, 16_{R} and the center panel bottom member 56 cooperate to define a doorway insert bottom face 14.

Illustrated in FIGS. 1 and 2 is a conventional doorway 70 including a door liner 72 on either side of the door frame and under the lintel. A door stop 74 is provided along the center of each of the door liners 72. Decorative trim 76 is provided around the doorway 70, and typically extending away from the outer surface 82 of the wall 80 in which the door is installed. The left and right panels 16_{L}, 16_{R} are removably secured to the left and right door liners 72_{L}, 72_{R}, respectively, and to the upper door liner 72_{U}. It will be understood that the right and left panels 16_{L}, 16_{R} may further be removably secured to either of the door trim 76 and/or the door stops 74. The center panel 40 is then releasably received on the interior end 24 of each of the left and right panels 16_{L}, 16_{R}. The specific structure which accomplishes a cooperative engagement between the center panel 40 and each of the left and right panels 16_{L}, 16_{R} is described below.

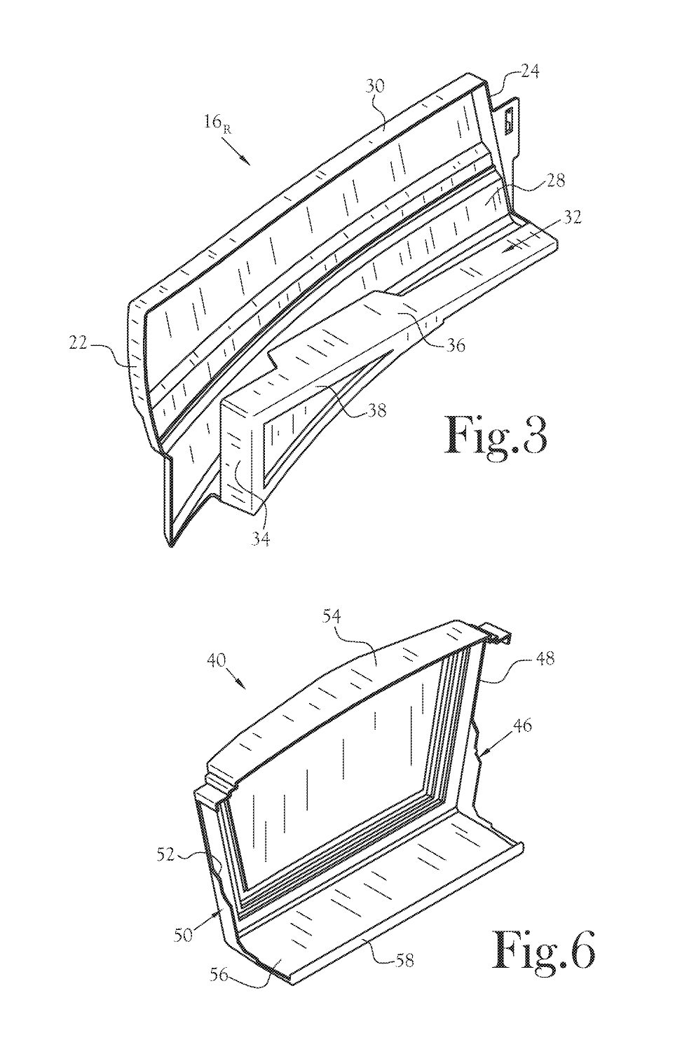

FIG. 3 illustrates a perspective view of the reverse of the right panel 16_{R}. The reverse of the left panel 16_{L} is substantially a mirror image thereof. Accordingly, while the right panel 16_{R} is described below, it will be understood that the left panel 16_{L} is similar, but reversed. In the illustrated embodiment, an attachment member 32 is carried on the rear face 28 of the right panel 16_{R}. It will be understood that other various configurations of the attachment member 32 may be incorporated with similar results without requiring it to be carried on the rear face 28 of the right panel 16_{R}. The attachment member 32 is dimensioned to engage the right door liner 72_{R} and the upper door liner 72_{U}. To this extent, the attachment member 32 defines a vertical engagement surface 34 and a horizontal engagement surface 36. The vertical engagement surface 34 is disposed on the left hand side of the attachment member 32 when looking at the reverse of the right panel 16_{R}. It follows that for the left panel 16_{L}, the vertical surface 34 is on the right hand side when looking at the reverse of the left panel 16_{L}. The horizontal engagement surface 36 is defined by the top surface of the attachment member 32.

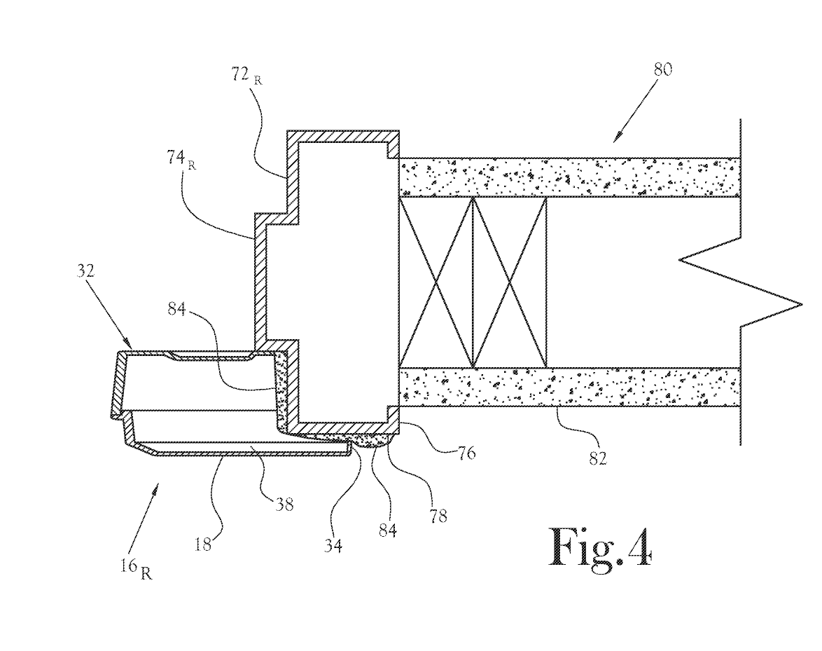

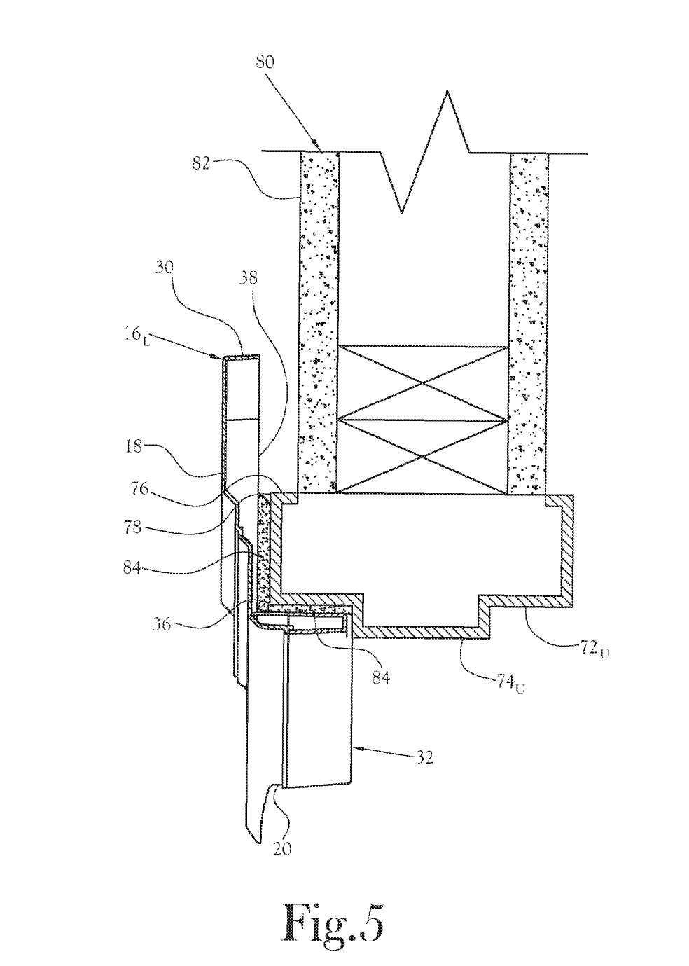

In the preferred embodiment, the attachment member 32 is dimensioned such that the right panel rear face 28 engages the front face 78 of the door trim 76 when installed, and such that the attachment member 32 extends proximate to the door stop 74, one embodiment being illustrated in FIGS. 4 and 5. In the illustrated embodiment, the attachment member 32 engages the door stop 74, but one skilled in the art will appreciate that the attachment member 32 need not engage the door stop 74. Depending upon the decorative configuration of the right panel 16_{R}, a portion of the rear face 38 of the attachment member 32 may be visible when the right panel 16_{R} is installed. Accordingly, the attachment member rear face 38 of the illustrated embodiment includes a decorative element. However, it will be understood that the decorative element rear face 38 may not include a decorative element, especially in those configurations where little or none of the attachment element rear face 38 is visible when installed.

FIG. 4 illustrates a cross-section of the right panel 16_{R} when installed in a conventional doorway 70, from a top plan view. The attachment member 32 in the illustrated embodiment is dimensioned such that the rear face 38 of the attachment member 32 engages a portion of the right doorstop 74_{R}. FIG. 5 illustrates a cross-section of the left panel 16_{L} when installed in a conventional doorway 70, from a right end view. The attachment member 32 in the illustrated embodiment is dimensioned such that the rear face 38 of the attachment member 32 also engages a portion of the upper doorstop 74_{U}. In the illustrated embodiment, the right panel 16_{L} is secured in the doorway 70 using conventional non-destructive fasteners 84, such as the illustrated double-sided mounting tape. As shown in FIG. 4, in the illustrated embodiment, the fasteners 84 are disposed between the vertical engagement surface 34 and the right door liner 72_{R}, and between the attachment member rear face 38 and the right door stop 74_{R}. As shown in FIG. 5, the fasteners 84 are disposed between the horizontal engagement surface 36 and the upper door liner 72_{U}, and between the right panel rear face 28 and the door trim front face 78. However, it will be understood that more or fewer fasteners 84 may be used, and in various other dispositions as required. Further, it will also be understood that for a more permanent attachment, conventional fasteners such as screws or nails may be used.

The fasteners 84 are selected on various criteria. Among these include the weight of the doorway insert 10, the duration through which the doorway insert 10 is to be installed, and the type and condition of the various surfaces to which the doorway insert 10 is to be attached. To this extent, the doorway insert 10 is preferably fabricated from lightweight materials in order to minimize the strength requirements of the fasteners 84. In the preferred embodiment, the doorway insert 10 is fabricated from molded plastic or resin, or other similar, durable material.

Illustrated in FIG. 6 is a perspective view of the reverse of the center panel 40. The center panel defines a left end 46 and a right end 50, each defining a contour configured to closely receive the contour of the front face 18 of the left and right panels 16_{L}, 16_{R}. It will be understood that while the left and right panels 16_{L}, 16_{R} are described as being configured to be mirror images of each other, it is within the spirit of the present invention to provide asymmetry between the left and right panels 16_{L}, 16_{R}. In order to encompass either situation, it will be understood that the center panel right end 50 defines a contour to cooperatively receive the contour of the right panel front face 18. Likewise, the center panel left end 46 defines a contour to cooperatively receive the contour of the left panel front face 18.

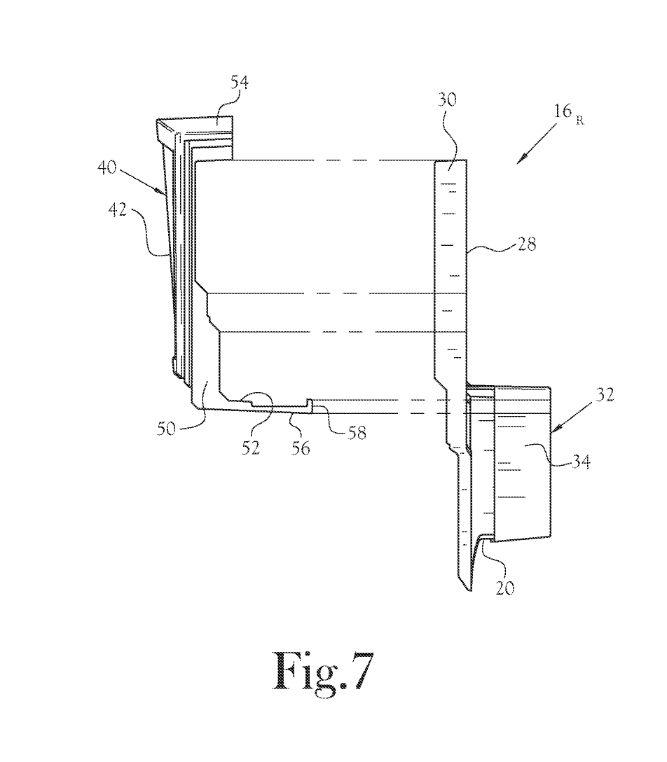

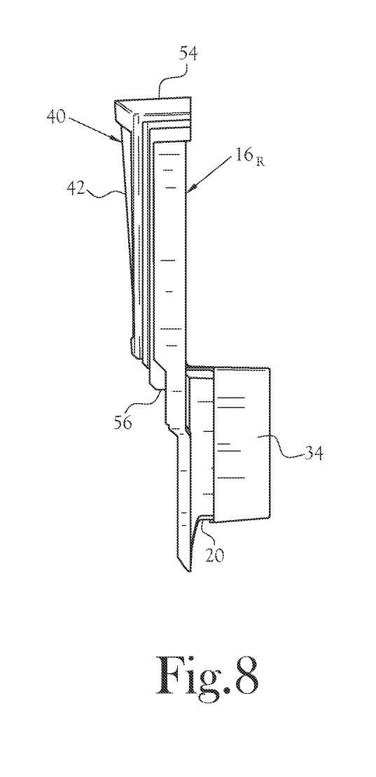

The center panel 40 further defines a top member 54 configured to engage the top surface 30 of each of the left and right panels 16_{L}, 16_{R}. While not illustrated, it will be understood that the configuration of the center panel top member 54 and the left and right panel top surfaces 30 may define a locking engagement. A bottom member 56 is also defined to be received under the bottom faces 20 of each of the left and right panels 16_{L}, 16_{R}. In the illustrated embodiment, the bottom member 56 defines an upward extension 58 to be received behind the left and right panels 16_{L}, 16_{R} in order to maintain the relative position of the center panel 40 with respect to each of the left and right panels 16_{L}, 16_{R}. Illustrated in FIG. 7 is an exploded end view illustrating the cooperative engagement between the center panel 40 and each of the left and right panels 16_{L}, 16_{R}. FIG. 8 then illustrates the same view with the panels 16_{L}, 16_{R}, 40 assembled.

In an alternate embodiment, not illustrated, the center panel 40 is mounted either on the left and right panel front faces 18 using conventional fasteners 84, and/or on the surface 82 of the wall 80 in similar fashion to the left and right panels 16_{L}, 16_{R}. In this embodiment, it will be understood that the bottom member 56 and upward extension 58 are not required.

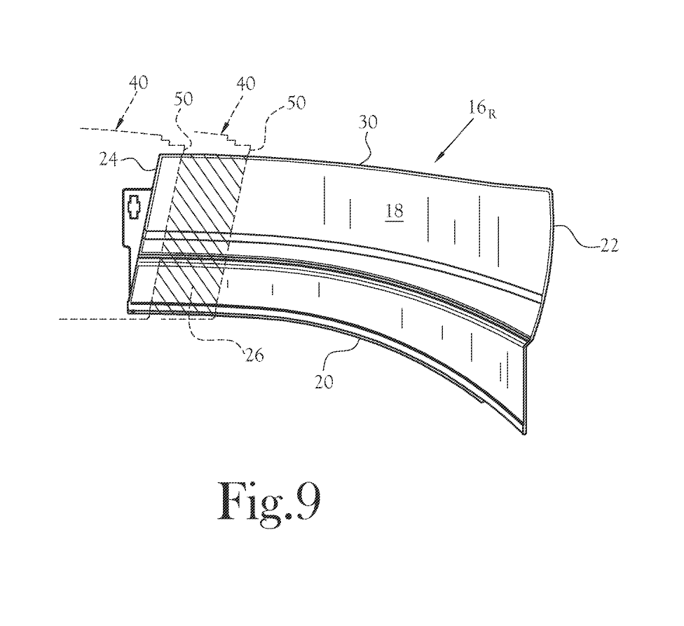

The doorway insert 10 of the present invention is adapted to be received within various sized doorways 70. Illustrated in FIG. 9 is the adjustability of the center panel 40 with respect to the right panel 16_{R}. The center panel 40 is illustrated in phantom in two positions. At least the area 26 of the interior end 24 of the right panel 16_{R}—shown with hatching, and bounded by the right end 50 of the center panel 40 in both positions, and the bottom and top faces 20, 30 of the right panel 16_{R}—defines a continuous cross section along a line parallel to the right end 50 of the center panel 40. As a result of the continuous cross section in this region 26, the center panel 40 is allowed to closely and cooperatively receive the right panel 16_{R} at any location within the area 26. Thus, the doorway insert 10 may be adjusted a length equal to twice the width of the area 26, taking into account both the left and right panels 16_{L}, 16_{R}.

Because the doorway insert 10 is removably secured within the doorway 70, it will be understood that various configurations of the doorway insert 10 may be selectively used for various purposes. The doorway insert 10 may be configured to convey a particular architectural style, a theme for a party or child's room, or many other various reasons. Further, the doorway insert 10 may be decorated to meet the needs of the user. Specifically, the doorway insert may be painted to match colors in the room, to include characters or a child's name in the child's room, various sports logos for a gathering of a sports crowd, or for any other tastes and preferences. Further, several center panels 40 may be provided to be interchangeable to easily change the look of the doorway insert 10—such as with the aforementioned children's characters or sports logos—without removing the left and right panels 16_{L}, 16_{R}. For those uses of the doorway insert 10 where it is to be removed and replaced frequently, it will be understood that a less permanent fastener 84 such as a reusable putty-type adhesive.

The installation and removal of the doorway insert 10 is easily accomplished without the need for any tools. The surfaces of the doorway 70 to which the left and right panels 16_{L}, 16_{R} are to be attached are first cleaned to ensure a clean surface. Fasteners 84 are secured to each of the left and right panel attachment members 32 at selected locations. The left panel 16_{L} is then secured in the left corner of the doorway 70 using the fasteners 84 affixed to its attachment member 32. Similarly, the right panel 16_{R} is secured in the upper right corner of the doorway 70. The center panel 40 is then fit into place by placing the upward extension 58 behind the left and right panels 16_{L}, 16_{R} and then rotating the center panel 40 up until the top member 54 is received over the top surface 30 of each of the left and right panels 16_{L}, 16_{R}. The center panel 40 is installed proximate the center of the doorway 70, but may be slid to either side in order to center it if necessary. For other configurations of the center panel 40 with respect to the left and right panels 16_{L}, 16_{R}, other methods for installing the center panel 40 may be used as well.

To remove the doorway insert 10, the steps are essentially reversed. The center panel 40 is removed by pulling the top member 54 out of engagement with the left and right panels 16_{L}, 16_{R}, and then the upward extension 58 is brought out of engagement with the left and right panels 16_{L}, 16_{R}. The left and right panels 16_{L}, 16_{R} are then removed, as well as the fasteners 84.

From the foregoing description, it will be recognized by those skilled in the art that a decorative doorway insert for enhancing the look of a doorway has been provided. The doorway insert is provided for easy, non-destructive and non-permanent installation. The doorway insert is adjustable such that it will easily be mountable within door openings of varying widths, and is removable in order to conveniently and inexpensively alter the look of the doorway as desired. The doorway insert may also be modified to meet the decorative tastes of the used, thereby being able to accomplish any desired look.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, I claim:

1. A decorative doorway insert for enhancing the look of a doorway including at least a left door liner, a right door liner and an upper door liner, said doorway insert comprising:
a left panel adapted to be secured in a corner formed by the left door liner and the upper door liner, said left panel defining a decorative front face, a decorative bottom face, a decorative outer end, and an interior end;
a right panel adapted to be secured in a corner formed by the right door liner and the upper door liner, said right panel defining a decorative front face, a decorative bottom face, a decorative outer end, and an interior end; and
a center panel adapted to be secured over a portion of each of said left panel and said right panel, said center panel defining a decorative front face and a decorative bottom edge.

2. The decorative doorway insert of claim 1 wherein said center panel defines:
a left end receptor for receiving and cooperatively engaging at least a portion of said left panel interior end, said left end receptor defining a contour to closely receive a contour defined by said portion of said left panel interior end; and
a right end receptor for receiving and cooperatively engaging at least a portion of said right panel interior end, said right end receptor defining a contour to closely receive a contour defined by said portion of said right panel interior end.

3. The decorative doorway insert of claim 2 wherein:
at least a portion of said left panel interior end defines a continuous cross-section, whereby said left panel interior end is adjustably received within said center panel left end receptor; and
at least a portion of said right panel interior end defines a continuous cross-section, whereby said right panel interior end is adjustably received within said center panel right end receptor;
whereby said decorative doorway insert defines an adjustable width to accomplish selective mounting of said decorative doorway insert in one of various doorways having varying widths.

4. The decorative doorway insert of claim 2 wherein said center panel further defines a top member configured to engage a top surface defined by said left panel and a top surface defined by said right panel, and a bottom member configured to engage said left panel bottom surface and said right panel bottom surface, said bottom member defining an upward extension configured to be received behind said left panel and said right panel in order to establish a locking engagement between said center panel and each of said left panel and said right panel.

5. The decorative doorway insert of claim 1 wherein:
said left panel includes an attachment member carried on a rear face of said left panel, said left panel attachment member defining a vertical attachment surface configured to engage the left door liner and a horizontal attachment surface configured to engage the upper door liner; and
said right panel includes an attachment member carried on a rear face of said right panel, said right panel attachment member defining a vertical attachment surface configured to engage the right door liner and a horizontal attachment surface configured to engage the upper door liner.

6. The decorative doorway insert of claim 1 wherein the doorway further includes left, right and upper door stops disposed along a center of the left, right and upper door liners, respectively, and decorative trim disposed on an outer surface of a wall in which the doorway is disposed and about a perimeter of the doorway, and wherein:
said left panel is removably secured to at least one of the left door liner, the left door stop, the upper door liner, the upper door stop, and the decorative trim; and
said right panel is removably secured to at least one of the right door liner, the right door stop, the upper door liner, the upper door stop, and the decorative trim.

7. The decorative doorway insert of claim 6 wherein:
said left panel attachment member further defines a rear face, said left panel attachment member being dimensioned such that said rear face is positioned proximate to the left door stop and the upper door stop; and
said right panel attachment member further defines a rear face, said right panel attachment member being dimensioned such that said rear face is positioned proximate to the right door stop and the upper door stop.

8. The decorative doorway insert of claim 1 wherein:
said left panel is secured in the doorway using at least one conventional non-destructive fastener; and
said right panel is secured in the doorway using at least one conventional non-destructive fastener.

9. A decorative doorway insert for enhancing the look of a doorway including at least a left door liner, a right door liner and an upper door liner, said doorway insert comprising:
a left panel adapted to be secured in a corner formed by the left door liner and the upper door liner, said left panel defining a decorative front face, a decorative bottom face, a decorative outer end, and an interior end, said left panel including an attachment member carried on a rear face of said left panel, said left panel attachment member defining a vertical attachment surface configured to engage the left door liner and a horizontal attachment surface configured to engage the upper door liner;
a right panel adapted to be secured in a corner formed by the right door liner and the upper door liner, said right panel defining a decorative front face, a decorative bottom face, a decorative outer end, and an interior end, said right panel including an attachment member carried on a rear face of said right panel, said right panel attachment member defining a vertical attachment surface configured to engage the right door liner and a horizontal attachment surface configured to engage the upper door liner; and
a center panel adapted to be secured over a portion of each of said left panel and said right panel, said center panel defining a decorative front face and a decorative bottom edge, said center panel defining:
a left end receptor for receiving and cooperatively engaging at least a portion of said left panel interior end, said left end receptor defining a contour to closely receive a contour defined by said portion of said left panel interior end; and
a right end receptor for receiving and cooperatively engaging at least a portion of said right panel interior end, said right end receptor defining a contour to closely receive a contour defined by said portion of said right panel interior end.

10. The decorative doorway insert of claim 9 wherein:
at least a portion of said left panel interior end defines a continuous cross-section, whereby said left panel interior end is adjustably received within said center panel left end receptor; and
at least a portion of said right panel interior end defines a continuous cross-section, whereby said right panel interior end is adjustably received within said center panel right end receptor;
whereby said decorative doorway insert defines an adjustable width to accomplish selective mounting of said decorative doorway insert in one of various doorways having varying widths.

11. The decorative doorway insert of claim 9 wherein said center panel further defines a top member configured to engage a top surface defined by said left panel and a top surface defined by said right panel, and a bottom member configured to engage said left panel bottom surface and said right panel bottom surface, said bottom member defining an upward extension configured to be received behind said left panel and said right panel in order to establish a locking engagement between said center panel and each of said left panel and said right panel.

12. The decorative doorway insert of claim 9 wherein the doorway further includes left, right and upper door stops disposed along a center of the left, right and upper door liners, respectively, and decorative trim disposed on an outer surface of a wall in which the doorway is disposed and about a perimeter of the doorway, and wherein:
said left panel is removably secured to at least one of the left door liner, the left door stop, the upper door liner, the upper door stop, and the decorative trim; and
said right panel is removably secured to at least one of the right door liner, the right door stop, the upper door liner, the upper door stop, and the decorative trim.

13. The decorative doorway insert of claim 12 wherein:
said left panel attachment member further defines a rear face, said left panel attachment member being dimensioned such that said rear face is engageable with the left door stop and the upper door stop; and
said right panel attachment member further defines a rear face, said right panel attachment member being dimensioned such that said rear face is engageable with the right door stop and the upper door stop.

14. The decorative doorway insert of claim 9 wherein:
said left panel is secured in the doorway using at least one conventional non-destructive fastener; and
said right panel is secured in the doorway using at least one conventional non-destructive fastener.

15. A method for installing a decorative doorway insert for enhancing the look of a doorway including at least a left door liner, a right door liner and an upper door liner, said doorway insert including a left panel defining an interior end; a right panel defining an interior end; and a center panel adapted to be secured on each of said left panel and said right panel, said method comprising the steps of:
a) installing said left panel in a corner of the doorway defined by the left door liner and the upper door liner;
b) installing said right panel in a corner of the doorway defined by the right door liner and the upper door liner; and
c) installing said center panel to cover at least a portion of each of said left panel interior end and said right panel interior end.

16. The method of claim 15 wherein said center panel defines:
a left end receptor for receiving and cooperatively engaging at least a portion of said left panel interior end, said left end receptor defining a contour to closely receive a contour defined by said portion of said left panel interior end; and
a right end receptor for receiving and cooperatively engaging at least a portion of said right panel interior end, said right end receptor defining a contour to closely receive a contour defined by said portion of said right panel interior end; and
wherein said step of c) attaching said center panel to said left panel interior end and said right panel interior end includes the steps of:
1) receiving said left panel interior end within said left end receptor; and
2) receiving said right panel interior end within said right end receptor.

17. The method of claim 16 wherein:
at least a portion of said left panel interior end defines a continuous cross-section, whereby said left panel interior end is adjustably received within said center panel left end receptor; and
at least a portion of said right panel interior end defines a continuous cross-section, whereby said right panel interior end is adjustably received within said center panel right end receptor;
whereby said decorative doorway insert defines an adjustable width to accomplish selective mounting of said decorative doorway insert in one of various doorways having varying widths; and
wherein said step of c) attaching said center panel to said left panel interior end and said right panel interior end further includes the steps of:
3) adjusting a position of said center panel along said left panel interior end and said right panel interior end.

18. The method of claim 15 wherein said center panel further defines a top member configured to engage a top surface defined by said left panel and a top surface defined by said right panel, and a bottom member configured to engage said left panel bottom surface and said right panel bottom surface, said bottom member defining an upward extension configured to be received behind said left panel and said right panel in order to establish a locking engagement between said center panel and each of said left panel and said right panel, said step of c) attaching said center panel to said left panel interior end and said right panel interior end further includes the steps of:
3) positioning said upward extension behind each of said left panel and said right panel to engage said upward extension with a rear face defined by said left panel and a read face defined by said right panel; and
4) rotating said center panel up to engage said center panel top member with each of said left panel top surface and said right panel top surface, whereby a locking engagement is established between said center panel and each of said left panel and said right panel.

19. The method of claim 15 wherein:
the doorway further includes left, right and upper door stops disposed along a center of the left, right and upper door liners, respectively, and decorative trim disposed on an outer surface of a wall in which the doorway is disposed and about a perimeter of the doorway;
said left panel includes an attachment member carried on a rear face of said left panel, said left panel attachment member defining a vertical attachment surface configured to engage the left door liner, a horizontal attachment surface configured to engage the upper door liner, and a rear face, said left panel attachment member being dimensioned such that said rear face is positioned proximate to the left door stop and the upper door stop, said left panel being removably secured to at least one of the left door liner, the left door stop, the upper door liner, the upper door stop, and the decorative trim; and
said right panel includes an attachment member carried on a rear face of said right panel, said right panel attachment member defining a vertical attachment surface configured to engage the right door liner, a horizontal attachment surface configured to engage the upper door liner, and a rear face, said right panel attachment member being dimensioned such that said rear face is positioned proximate to the right door stop and the upper door stop, said right panel being removably secured to at least one of the right door liner, the right door stop, the upper door liner, the upper door stop, and the decorative trim; and
wherein said step of a) installing said left panel in a corner of the doorway defined by the left door liner and the upper door liner includes the steps of:
1) positioning at least one conventional non-destructive fastener on said left panel attachment member; and
2) securing each fastener to at least one of the left door liner, the left door stop, the upper door liner, the upper door stop, and the decorative trim; and
wherein said step of b) installing said right panel in a corner of the doorway defined by the right door liner and the upper door liner includes the steps of:
1) positioning at least one conventional non-destructive fastener on said right panel attachment member; and
2) securing each fastener to at least one of the right door liner, the right door stop, the upper door liner, the upper door stop, and the decorative trim.
